(19) United States
(12) Patent Application Publication
(10) Pub. No.: US 2003/0129997 A1
(43) Pub. Date: Jul. 10, 2003

(54) Conference feature for cordless telephone systems

(75) Inventors: Holger Steinbach, Round Rock, TX (US); Jeff Stripling, Austin, TX (US); Andy Butcher, Cedar Park, TX (US); Herc Kwan, Austin, TX (US); Joel Adams, Austin, TX (US)

Correspondence Address: Elsa Keller, Legal Administrator, Siemens Corporation, Intellectual Property Department, 170 Wood Avenue South, Iselin, NJ, 08830, US

(73) Assignee: Siemens Information and Communication Mobile LLC

(21) Appl. No.: 10/374,218

(22) Filed: Feb. 25, 2003

Related U.S. Application Data
(63) Continuation of application No. 09/478,939, filed on Jan. 6, 2000.
(60) Provisional application No. 60/129,697, filed on Apr. 16, 1999.

(51) Int. Cl. H04Q 7/20

(52) U.S. Cl. 455/465; 455/403

(57) ABSTRACT

A system and method allow a user of a parallel cordless handset to join in an ongoing communication. A conference circuit is placed on the ongoing conversation and the parallel handset is bridged into the conversation. The system and method can also bridge in data transmissions. An alert can provide notification to the handset already in the conversation, the handset attempting to join the conversation, or both. The system can be set up to allow access to the conversation upon election of either handset user or, alternatively, upon election of both handset users. Alternatively, the access can be granted without requiring election (automatically) or can be mandatory. More than one handset can be joined into the ongoing communication.

### FIELD OF THE INVENTION

This invention relates to cordless and wireless telephone systems.

### BACKGROUND OF THE INVENTION

Cordless and wireless telephone systems are proliferating. In many households and small businesses, several telephone sets are connected to the same central office line. With wireline parallel phone sets, when a conversation is in progress, anyone can join the conversation simply by going off hook. However, in cordless systems, the parallel phones cannot automatically share a channel, so handsets controlled by the base station cannot join in ongoing conversations.

When it is desired by all parties, it is a welcome convenience to join conversations simply by going off-hook. However, in some circumstances, it is advantageous to restrict, regulate, or announce access to ongoing communications, to prevent unauthorized parties from eavesdropping on sensitive conversations or intercepting data. Furthermore, it can be embarrassing for a person who inadvertently breaks in on an ongoing conversation. What is needed is convenient, controlled parallel phone access to ongoing conversations and/or ongoing data transmissions in cordless phones.

### SUMMARY OF THE INVENTION

A parallel telephone is introduced to an ongoing conversation by means of a conference bridge feature. In a preferred embodiment, an interface mediates the use of a barge-in feature. (A barge-in feature is conventionally used to interrupt ongoing conversations by placing a conference circuit on the call; it is typically used to “barge in” in an emergency.) An alert notifies call participants of the proposed interruption. In one alternative, participants can elect whether to allow the parallel telephone to join the conversation (or, alternatively, to intercept the data transmission).

### BRIEF DESCRIPTION OF THE DRAWINGS

FIG. 1 is a schematic depiction of a system of the background art.

FIG. 2 is a schematic depiction of a system of the invention.

FIG. 3 is a flow chart of a method in accordance with the invention.

FIG. 4 is a detailed flow chart of a step of a method in accordance with the invention.

### DESCRIPTION OF THE PREFERRED EMBODIMENTS

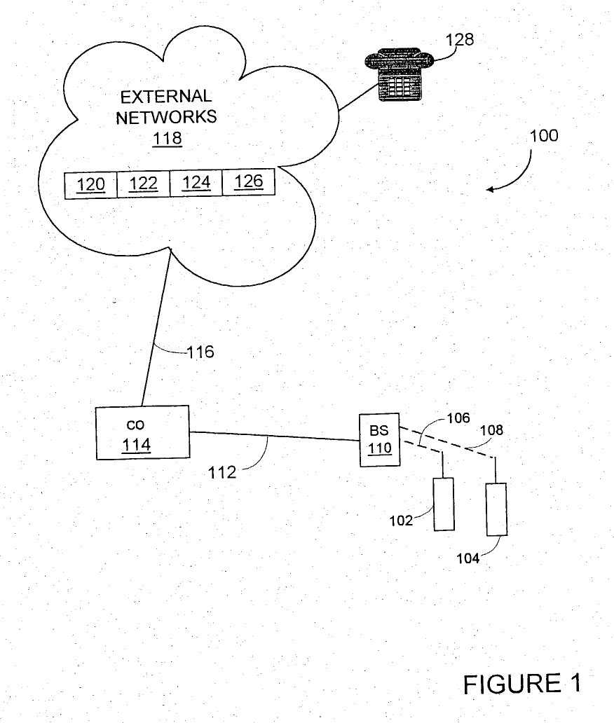

A system 100 of the background art is shown in FIG. 1. In FIG. 1, two cordless handsets 102 and 104 have respective wireless communication links 106 and 108 to a base station 110. In the most commonly used systems, wireless communication links 106 and 108 use radio signals. They can also use other types of signal, such as infrared. Two or more handsets controlled by the same base station are known as parallel phones.

Base station 110 is linked by wireline 112 to a central office 114, and has an assigned landline telephone number. (More than one number may be assigned.) Central office 114 is in turn linked by wireline 116 to external networks 118. External networks 118 include public switched telephone network (PSTN) 120, integrated service digital network (ISDN) 122, the public land mobile network (PLMN) 124, and the public switched packet data network (PSPDN) 126. External networks 118 connect to other phones and data and communication devices, including telephone 128. In system 100, a call in progress between telephone 128 and handset 102 cannot be joined by handset 104.

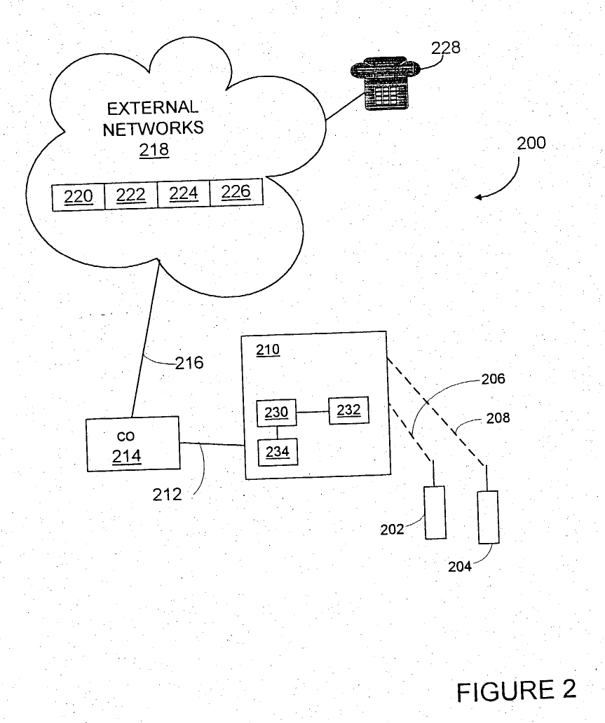

System 200 in accordance with the present invention is schematically depicted in FIG. 2. FIG. 2 includes two cordless handsets 202 and 204 with respective wireless communication links 206 and 208 to a base station 210. In the most commonly used systems, wireless communication links 206 and 208 are by radio signal. They can use other types of signals, such as infrared.

Base station 210 is linked by wireline 212 to a central office 214. Central office 214 is in turn linked by wireline 216 to external networks 218. External networks 218 include public switched telephone network (PSTN) 220, integrated service digital network (ISDN) 222, the public land mobile network (PLMN) 224, and the public switched packet data network (PSPDN) 226. External networks 218 connect to other phones and data and communication devices, including telephone 228. Links need not be by wireline, although they most commonly are.

In addition, base station 210 includes a processor 230, a conference circuit 232, and an alert 234. In the example depicted in FIG. 2, a call is in progress between handset 202 and telephone 228. If handset 204 goes off-hook, a code is sent from handset 204 to a switch within base station 210, which causes a conference circuit 234, also known as a conference bridge, to be placed on the call. Notification from alert 234 can be provided to the user of handset 202, the user of handset 204, or both, indicating that handset 204 is about to join the call. The system can be configured so that either or both handsets must elect to allow handset 204 to join in the communication. Handset 204 then joins in the call. Handsets can be equipped with an alert-enable/disable and join enable/disable so that the alert and join features can be enabled and disabled for particular calls.

In an alternative embodiment, the call is joined unconditionally. Unconditional joining allows a parallel handset to participate in an ongoing call without selection by either handset. Unconditional joining can be desirable in certain circumstances, such as allowing emergency services immediate access or allowing managers to supervise or interrupt calls to better manage employees or provide improved customer service. As defined, unconditional joining cannot be disabled; however, the alert can be implemented with unconditional joining.

The conference bridge is preferably implemented by allowing the participants to share a channel. In one embodiment, using a system described in U.S. Pat. No. 5,128,928 to Wilder, et al., the conference bridge linearly combines digitized audio data received from the parallel handsets over successive time slice slots in a single frame on a real time basis, so that parties can be added or removed by adding or removing assignments of the connections to the time slice slots. Alternatively, the conference bridge can be implemented in other ways, as known to those skilled in the art.

In alternatives, the system can be implemented through a PBX and the conversation-joining feature can be implemented through a switch in the PBX. Similarly, for emergency unconditional joining, the feature can be implemented through a central office switch.

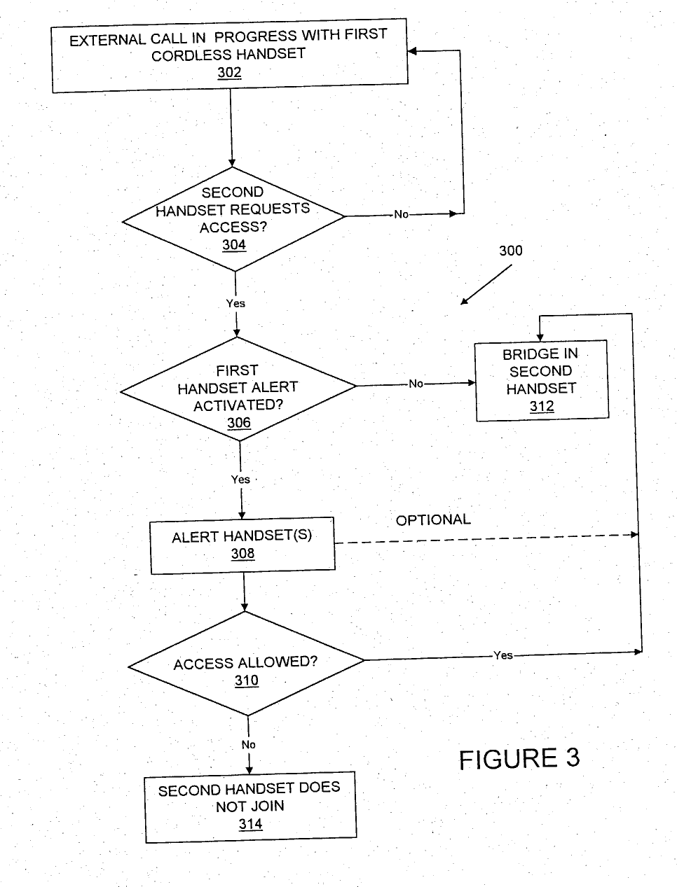

A method 300 of the invention is depicted in FIG. 3. At a step 302, the first handset has an external call is in progress, e.g., a call is in progress between telephone 228 and handset 202. At a step 304, it is determined whether a second handset (e.g., handset 204) requests access. Access can be requested by the handset going off-hook. If access is not requested, the method loops back to step 302, and the call in progress continues.

If access is requested (the answer to step 304 is “yes”), the method proceeds to a step 306, and it is determined whether a phone alert is activated. If the alert is not activated, the method proceeds directly to step 312, and the second handset is bridged in.

If the alert is activated (the answer to step 306 is “yes”), the handset or handsets are alerted, at a step 308. (It should be noted that the alert can be to either handset or to both handsets.) In one alternative, indicated in FIG. 3 by dashed lines, the alert is a signal only, with no action required by users. In that case, the method proceeds directly to step 312 and the second handset is bridged in.

If the alert is activated, the method proceeds to a step 310, where it is determined whether access is allowed. Access can be allowed automatically. In an alternative, the first handset user can be required to allow access, for example, by pressing a key on the first handset. If access is allowed, the method proceeds to step 312, and the second handset is bridged in. If access is not allowed, the second handset is not allowed to join the communication, at a step 314. Steps of method 300 can be repeated to join in more parallel handsets.

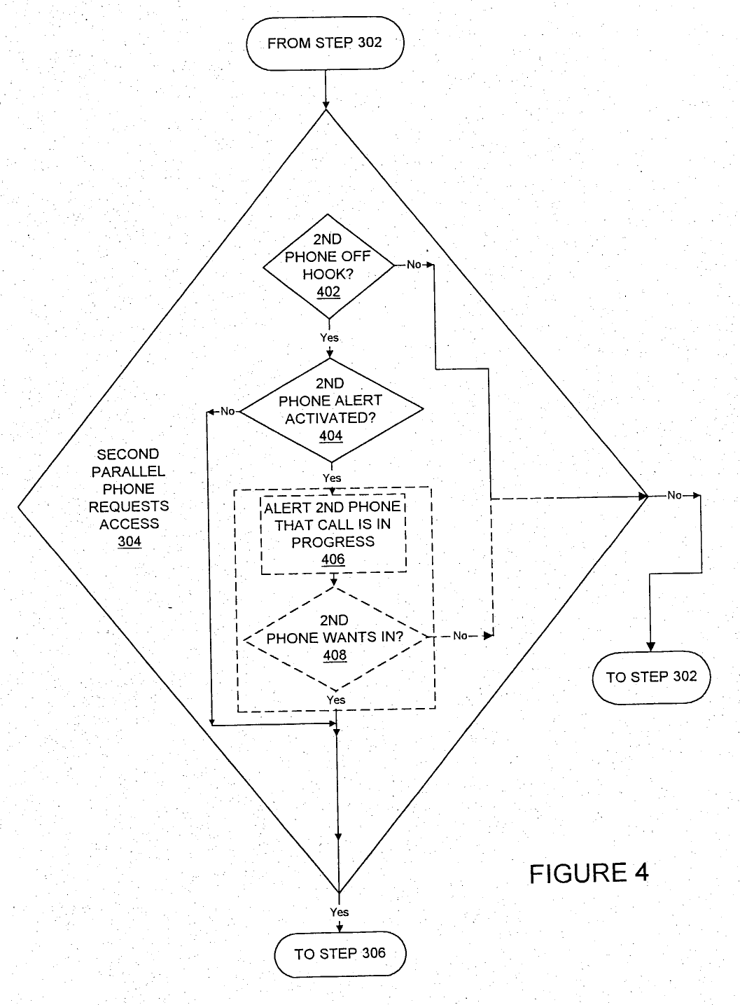

Substeps 402-408 of step 304 are shown in FIG. 4. (In this example, the second handset requests access by going off hook. In alternatives, access can be requested in other ways, for example, by pressing a key, before going off hook.) At a step 402, the method checks whether the second handset is off hook. If not, the method returns to step 302. If the second handset is off hook, the method goes to a step 404, and the method checks whether the second handset alert is activated. If the alert is not activated (which also includes the case where there is no second handset alert), the method proceeds to step 306.

If the second handset alert is activated, the method optionally proceeds to steps 406 and 408. In optional step 406, the second handset is alerted. In optional step 408, the method checks whether the second handset wants to join the communication. This step can prevent the second handset from inadvertently interrupting the ongoing call. If the second handset elects not to join the communication, the method returns to step 302. If the second handset wants to join the communication (the answer to decision block 408 is “yes”), the method proceeds to step 306, and continues as shown in FIG. 3.

In another alternative, after the handset or handsets are alerted, the system determines whether the second handset is allowed access to the communication in progress. Access can be controlled by requiring selection by the user of the first handset; selection by the user of the second handset; or selection by both handset users.

Information about the call can be displayed on the cordless handsets or on an external display. When a user goes off hook on a parallel phone and a call is already in progress, the existence of the conversation is indicated on a display on a handset. The information can be displayed on either or both of the parallel handsets, and can also optionally be displayed on an external telephone display. Alternatively, the alert can be by audio indication, as for example by a special tone. Other information can be displayed or indicated. For example, identification of the external telephone (for example, by caller ID or by capture of the dialed number) or the length of time the call has been in progress can be displayed. For another example, a business can display information about the type of ongoing call. By knowing the type of call, the business can effectively manage their telephones. A product specialist can join a call placing an order, and a tech support technician can join a support call.

When access is not allowed automatically, pressing a key, pressing a defined key sequence, or selecting of a displayed option can be set up to allow the user to join the ongoing conversation, or alternatively, allow him to signal his wish to join the conversation. A tone can alert the other parallel phone or, alternatively, both the parallel and external phones.

A program executed by a processor in the base station can implement and control parallel phone access and selectively allow a second party to join the ongoing communication. Either or both handsets can be required to press a key or a sequence of keys to be allowed to join. In addition, codes can be programmed to allow differential access, so that a person who knows the code can join a call and a person who does not know the codes cannot. Furthermore, codes can be assigned to people to grant access to particular calls. For example, imagine a telephone that receives both personal calls and calls for a home based business. Codes could be assigned so that family members can join personal calls but not business calls, based on caller ID, captured number, or selection by the first party to the call. Furthermore, a “privacy” selection can temporarily prevent parallel phones from joining the call, with access allowed again upon completion of the call. Alerts can be implemented at the handsets instead of at the base station.

For convenience, communication between two units has been referred to as a “conversation”; however, the invention is fully compatible with an exchange of data, as for example, data modem, teletype, or TTY. Also, for convenience, the devices in communication have been referred to as telephones; they can be any device that uses a connection compatible with the invention, such as two or more computers exchanging data over a telecommunications link, or a telephone exchanging data with a computer. The terms “wireless” and “cordless” should be construed to include any compatible non-landline system. The invention is compatible with use in any of wireless, cordless, cellular, and mobile telecommunications devices and systems.

A “handset” includes subscriber units, pagers, headsets, computers, and data devices that use telecommunications links. Although the discussion throughout is in terms of two handsets, those skilled in the art are aware that the system and method can be applied to conferencing more than two handsets. Those skilled in the art will be aware of numerous variations within the spirit of the invention, the scope of which is limited only by the following claims.

What is claimed is:

1. In a cordless telephone system, an apparatus for joining plural handsets controlled by the same base station into an ongoing communication, comprising:
a first handset;
a second handset;
a base station controlling the first and second handsets and providing communication links to telecommunications devices;
a processor included in the base station; and
a conference circuit;
such that, when a call is in progress between the telecommunications device and the first handset, the processor causes the conference circuit to be placed on the call in progress, allowing the second handset to join in the call in progress.

2. The system of claim 1 wherein the processor is a digital signal processor (DSP).

3. The system of claim 1 wherein the communication links are to at least one of the public switched telephone network, the integrated service digital network, the public land mobile network, and the public switched packet data network.

4. The system of claim 1 wherein the telecommunications device is one of a telephone, a modem-mediated computer, and a text device.

5. The system of claim 1 in which the processor causes the conference circuit to be placed on the call in progress in response to a selection by the user of the first handset.

6. The system of claim 1 in which the processor causes the conference circuit to be placed on the call in progress in response to a selection by the user of the second handset.

7. The system of claim 5 in which the processor presents information about the call to the user of the first handset before selection is made.

8. The system of claim 6 in which the processor presents information about the call to the user of the second handset before selection is made.

9. The system of claim 5 in which the selection is made in response to a prompt.

10. The system of claim 6 in which the selection is made in response to a prompt.

11. In a cordless telephone system with a first and a second handset controlled by a base station, during a communication that includes the first handset, a method for joining the second handset into the communication, comprising the steps:
the second handset requesting to be joined into the communication; and
bridging the second handset into the communication.

12. The method of claim 11 in which the request to be joined is initiated by taking the second handset off hook.

13. The method of claim 11, further comprising the step of:
alerting the first handset when the second handset requests to be joined into the communication.

14. The method of claim 13, further comprising the step of:
after the step of alerting the first handset, allowing the first handset to select whether to join the second handset into the communication, and joining the second handset into the communication only if the first handset so selects.

15. The method of claim 11, further comprising the step of:
alerting the second handset of the ongoing communication.

16. The method of claim 15, further comprising the step of:
after the step of alerting the second handset, allowing the second handset to select whether to join into the communication, and joining the second handset into the communication only if the second handset so selects.

17. The method of claim 11, further comprising the step of:
providing to the second handset information about the ongoing communication.

18. The method of claim 17 wherein the information is provided by display.

19. The method of claim 17 wherein the information is provided by audio.

20. The method of claim 11, further comprising the step of:
after the step of the second handset requesting to be joined into the communication, providing to the first handset information about the second handset.

21. The method of claim 20 wherein the information includes the identity of a user with whom the second handset is associated.

22. The system of claim 1 further comprising a mechanism that alerts the first handset when the second handset is about to join the call.

23. The system of claim 1 further comprising a mechanism that alerts the second handset when the second handset is about to join the call.
